(19) United States
(12) Patent Application Publication
(10) Pub. No.: US 2025/0058718 A1
(43) Pub. Date: Feb. 20, 2025

(54) BASE PLATE ATTACHMENT STRUCTURE WITH SWIVEL LOCK

(71) Applicant: Ford Global Technologies, LLC, Dearborn, MI (US)

(72) Inventors: Matthew B. Rutman, Westland, MI (US); Blaise Nugent, Brighton, MI (US); Eric Scott Levine, Novi, MI (US); Stuart C. Salter, White Lake, MI (US); Todd Rakus, Windsor (CA)

(21) Appl. No.: 18/235,441

(22) Filed: Aug. 18, 2023

(51) Int. Cl. B60R 11/00

(52) U.S. Cl. CPC B60R 11/00; B60R 2011/0078

(57) ABSTRACT

An attachment structure comprises a base support with a plurality of mounting feet and a lock separate from the base support. The base support is configurable to hold one or more items on a base plate. The plurality of mounting feet are configured to be received within one mounting aperture of the base plate.

### TECHNICAL FIELD

This disclosure relates generally to an attachment structure for securement to a base plate in a cargo area, and more particularly, to an attachment structure for accessories to be easily and quickly attached to the base plate.

### BACKGROUND

Vehicles transport various types of cargo. A user can, for example, rely on a vehicle to transport accessories, such as containers and tools, to and from a jobsite. The accessories that need to be transported can vary based on the tasks the user performs at the jobsite. Additionally, the accessories can vary in size and shape. Support surfaces in cargo or work areas may be configured to securely support the accessories.

### SUMMARY

In some aspects, the techniques described herein relate to an attachment structure, including: a base support with a plurality of mounting feet and a lock separate from the base support, wherein the base support is configurable to hold one or more items on a base plate, and wherein the plurality of mounting feet are configured to be received within one mounting aperture of the base plate.

In some aspects, the techniques described herein relate to an attachment structure, wherein the base support includes a base surface with at least one attachment interface that cooperates with a support member to hold the one or more items.

In some aspects, the techniques described herein relate to an attachment structure, wherein the base support includes a flange surrounding a majority of the base surface and a wall that transitions from an inner peripheral portion of the flange to the base surface such that the base surface comprises a raised boss.

In some aspects, the techniques described herein relate to an attachment structure, wherein the base support includes a first side with the base surface and a second side facing opposite the first side, and wherein the plurality of mounting feet extend outwardly of the second side of the base support and are spaced circumferentially apart from each other.

In some aspects, the techniques described herein relate to an attachment structure, wherein each mounting foot comprises a base end attached to the base support and which extends to a distal end that is bent at an angle relative to the base end.

In some aspects, the techniques described herein relate to an attachment structure, wherein the plurality of mounting feet are received within one single mounting aperture in an interference fit.

In some aspects, the techniques described herein relate to an attachment structure, wherein the attachment structure includes an arm that that has a first end associated with the base support and a second end associated with the lock.

In some aspects, the techniques described herein relate to an attachment structure, wherein the lock comprises at least one tab that extends outwardly of a base plate facing surface of the arm, and wherein the at least one tab is received within a lock aperture formed within the base plate, the lock aperture being different from the one mounting aperture.

In some aspects, the techniques described herein relate to an attachment structure, wherein the arm comprises an elongated body that extends from the first end to the second end, and wherein the second end of the arm comprises a distal end portion that is bent at an angle relative to the elongated body to provide a grippable portion.

In some aspects, the techniques described herein relate to an attachment system, including: a base plate having a plurality of mounting apertures; and an attachment structure comprising a base support with a plurality of mounting feet and a lock separate from the base support, wherein the base support is configurable to hold one or more items, and wherein the plurality of mounting feet are received within one mounting aperture of the plurality of mounting apertures to attach the attachment structure to the base plate.

In some aspects, the techniques described herein relate to an attachment system, wherein the base plate is mounted within a cargo area of a vehicle.

In some aspects, the techniques described herein relate to an attachment system, wherein the base support includes a base surface with at least one attachment interface that cooperates with a support member to hold the one or more items.

In some aspects, the techniques described herein relate to an attachment system, wherein the base support includes a first side with the base surface and a second side facing opposite the first side, and wherein the plurality of mounting feet extend outwardly of the second side of the base support and are spaced circumferentially apart from each other.

In some aspects, the techniques described herein relate to an attachment system, wherein the each mounting foot comprises a base end attached to the base support and which extends to a distal end that is bent at an angle relative to the base end, and wherein the plurality of mounting feet are received within a single mounting aperture of the plurality of mounting apertures in an interference fit.

In some aspects, the techniques described herein relate to an attachment system, wherein the attachment structure includes an arm that comprises an elongated body extending from a first end at the base support to a second end that includes the lock.

In some aspects, the techniques described herein relate to an attachment system, wherein the lock comprises at least one tab that extends outwardly of a base plate facing surface of the arm, and wherein the base support is rotatable to move the plurality of mounting feet between an unlock position and lock position, and wherein arm is rotatable to move the plurality of feet to the lock position while also aligning the at least one tab with a lock aperture formed within the base plate.

In some aspects, the techniques described herein relate to an attachment system, wherein the second end of the arm comprises a distal end portion that is bent at an angle relative to the elongated body to provide a grippable portion.

In some aspects, the techniques described herein relate to a method of, comprising: providing a base plate with a plurality of mounting apertures and a plurality of lock apertures that are separate from the plurality of mounting apertures; forming an attachment structure to comprise a base support with a plurality of mounting feet and a lock separate from the base support; inserting the plurality of mounting feet into a single mounting aperture of the plurality of mounting apertures; and inserting the lock into one lock aperture of the plurality of lock apertures.

In some aspects, the techniques described herein relate to a method, wherein after inserting the plurality of mounting feet into the single mounting aperture, the method further includes rotating the base support until the plurality of mounting feet are in a lock position and the lock aligns with one of the plurality of lock apertures.

In some aspects, the techniques described herein relate to a method that includes attaching one or more items to the base support.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1A illustrates a perspective view of a vehicle having a cargo bed equipped with base plates that can be used to secure an accessory according to an exemplary aspect of the present disclosure.

FIG. 1B illustrates a perspective view of a van having a cargo area equipped with base plates that can be used to secure accessories according to an exemplary aspect of the present disclosure.

FIG. 2A is a top perspective view of an example attachment structure.

FIG. 2B is a bottom perspective view of the attachment structure of FIG. 2A.

FIG. 2C is a side view of the attachment structure of FIG. 2A.

FIG. 3 is a side section view of the attachment structure of FIG. 2A installed on a base plate.

FIG. 4A is a top view of the attachment structure installed on a base plate in an unlocked position.

FIG. 4B is a top view of the attachment structure installed on a base plate in a locked position.

FIG. 5 is a perspective view of an attachment structure holding a first type of accessory.

FIG. 6 is a perspective view of an attachment structure holding a first second of accessory.

FIG. 7 is a side view of two attachment structures holding one accessory

### DETAILED DESCRIPTION

The subject disclosure provides an attachment structure that is selectively secureable to a base plate that includes a plurality of mounting apertures. The attachment structure is inserted into one of the mounting apertures and is then locked in place. An accessory can then be secured to, or supported by, the attachment structure. The base plates can be mounted to a floor structure or a wall structure. The attachment structure for an accessory can be quickly and easily attached/detached without the use of tools.

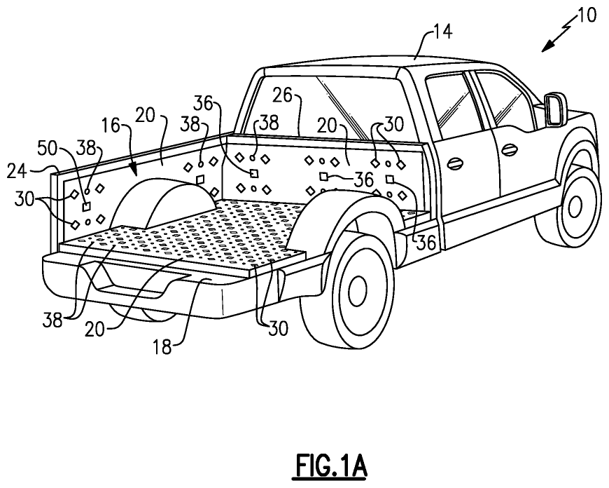

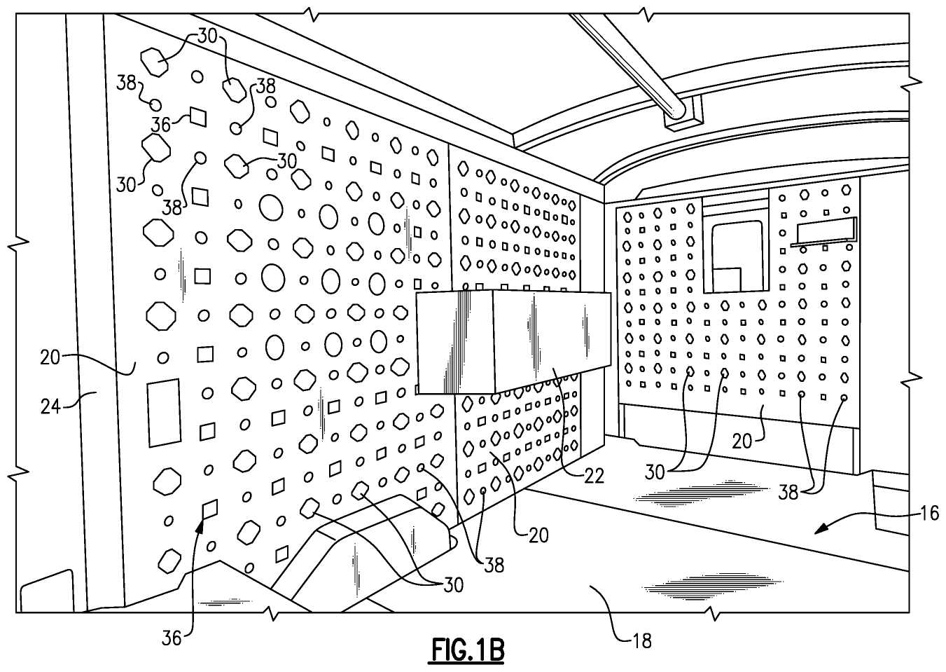

In one example, an attachment system for accessories is used on a vehicle. With reference to FIGS. 1A and 1B, a vehicle 10 includes a passenger compartment 14 and a cargo area 16 that is aft of the passenger compartment 14. The cargo area 16 has a floor 18. In this example, the vehicle 10 is a pickup truck. However, the vehicle 10 could be another type of vehicle in another example, such as a car, van, sport utility vehicle, etc. FIG. 1B shows an example of a van that incorporates a base plate 20 with an accessory attachment system.

In the exemplary embodiment, one or more base plates 20 are used to support one or more accessories and/or modules 22. In one example, the cargo bed 16 is defined by a pair of side walls 24 (only one is shown in FIG. 1A for purposes of clarity), a rear wall 26, and a tailgate (not shown). In one example, the base plates 20 are secured directly to walls 24, 26 and/or to the floor 18 of the cargo area 16 by fastening, welding, etc., at a first connection interface. The accessories and/or modules 22 can be secured to the vehicle 10 by engaging one or more of the base plates 20 via a second connection interface separate from the first connection interface.

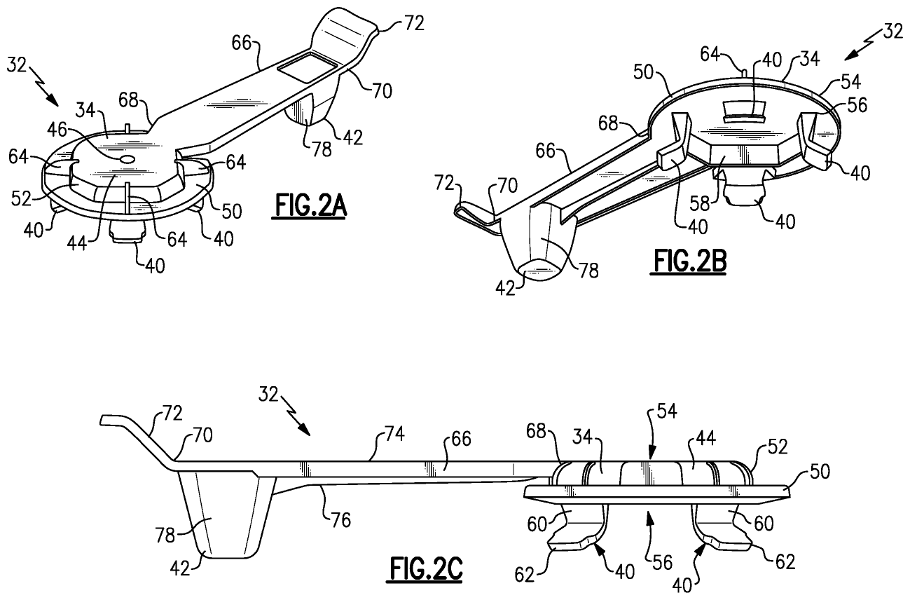

As shown in FIGS. 1A-1B, the base plates 20 include a plurality of mounting openings or apertures 30. As shown in FIGS. 2A-2C, an example attachment structure 32 comprises a base support 34 that includes one or more mounting feet 40. The attachment structure 32 can engage the base plate 20 by inserting the mounting feet 40 into a single mounting aperture 30 to provide a mechanical connection interface. The apertures 30 are spaced upwardly from the floor 18 or side wall 24, 26 by an open gap such that the mounting feet 40 from the attachment structure 32 can be easily inserted into the base plate 20. The accessory 22 can then be selectively secured to the base support 34 to attach the accessory 22 to the base plate 20. In one example, accessory 22 can then be removed from the base support 34 and replaced with a different accessory 22 as needed.

As discussed above, the base plates 20 with the mounting apertures 30 can be mounted to the walls 24, 26 or the floor 18 in the cargo area 16. In one example, the base plate 20 also includes other openings or apertures 36 (FIGS. 1A-1B) for a power connection interface, and further includes additional openings or locking apertures 38 for a locking feature that allows the base support 34 to be securely locked to the base plate 20. The power apertures 36 and locking apertures 38 are spaced apart and separate from each other and from the mounting apertures 30. In one example, the apertures 30, 36, 38 can have shapes and/or sizes that are different from each other. These sets of apertures 30, 36, 38 are provided at multiple locations on the base plate 20, and are formed in a desired pattern on the base plate 20 to allow for the base supports 34 to be mounted in various different locations as needed. In one example, the mounting apertures 30 are formed to have a diamond shape and are larger in size than the power apertures 36 and locking apertures 38.

In one example, the mounting apertures 30 are formed in a four corner pattern with a center power aperture 36 between the four corners, and with locking apertures 38 between adjacent mounting apertures 30. This pattern provides for easy and quick connect/disconnect.

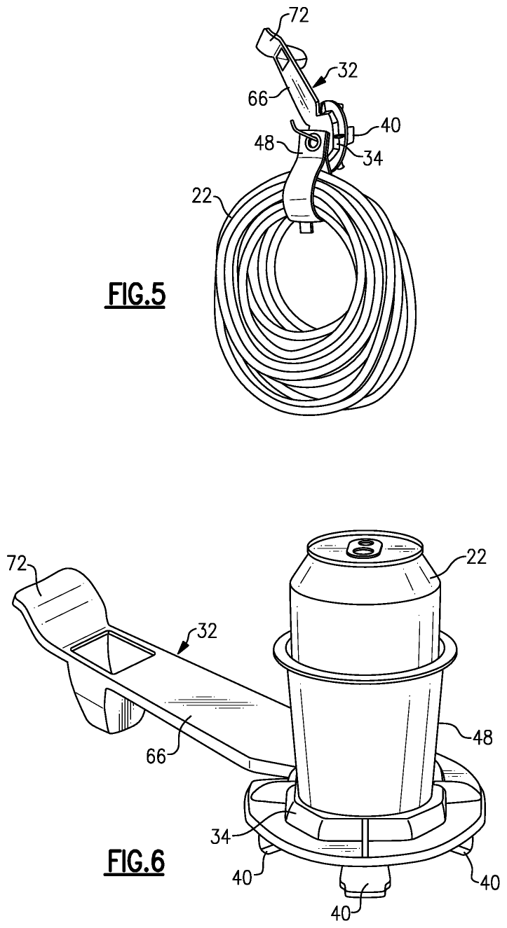

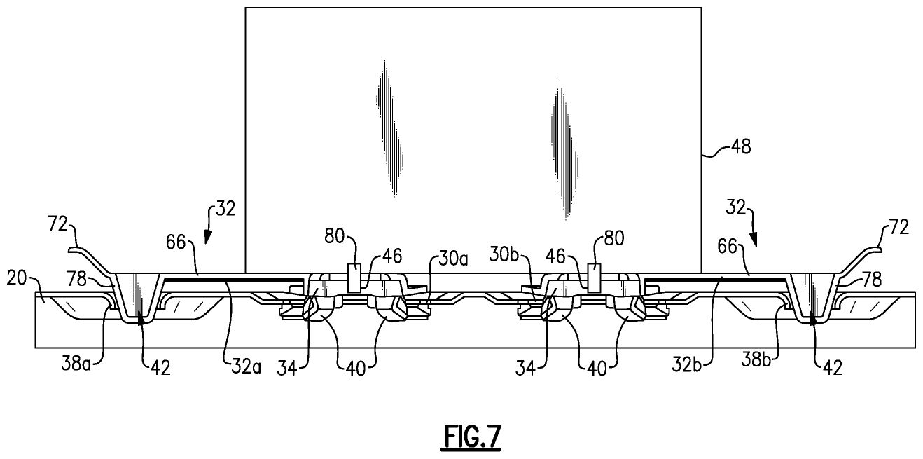

As discussed above, the attachment structure 32 includes a base support 34 with a plurality of mounting feet 40. The attachment structure 32 also includes a lock 42 separate from the base support 34. The base support 34 is configurable to hold one or more items or accessories 22 on the base plate 20. In one example, the plurality of mounting feet 40 are configured to be received within one mounting aperture 30 of the base plate 20 as shown in FIGS. 4A-B.

In one example shown in FIG. 2A, the base support 34 includes a base surface 44 with at least one attachment interface 46 that cooperates with a support member 48 (FIGS. 4-5) to hold the one or more items or accessories 22. In one example, the attachment interface 46 comprises a fastener attachment; however, other attachment interfaces could also be used, such as snap-fit for example. In one example, the area surrounding the attachment interface 46 is slightly thicker to reduce the chance of fastener pull-through during attachment of the support member 48. In one example, the support member 48 can comprise a loop structure, cup holder, camera grip, smart device holder, etc.

In one example, the base support 34 includes a flange 50 surrounding a majority of the base surface 44 and a wall 52 that transitions from an inner peripheral portion of the flange 50 to the base surface 44 such that the base surface 44 comprises a raised boss. In one example, the base surface 44 comprises a generally flat surface that receives the support member 48. In one example, gussets 64 are provided that extend from an outer peripheral portion of the flange 50 to the wall 52 to increase rigidity. In one example, the gussets 64 are circumferentially spaced apart from each other and aligned with the feet 40.

The base support 34 includes a first side 54 with the base surface 44 and a second side 56 facing opposite the first side 54. In one example, the plurality of mounting feet 40 extend outwardly of the second side 56 of the base support 34 and are spaced circumferentially apart from each other as shown in FIG. 2B. In one example, the base support 34 includes a flange portion 58 that extends outwardly of the second side 56 of the base support 34. In one example, the mounting feet 40 extend outwardly of the flange portion 58.

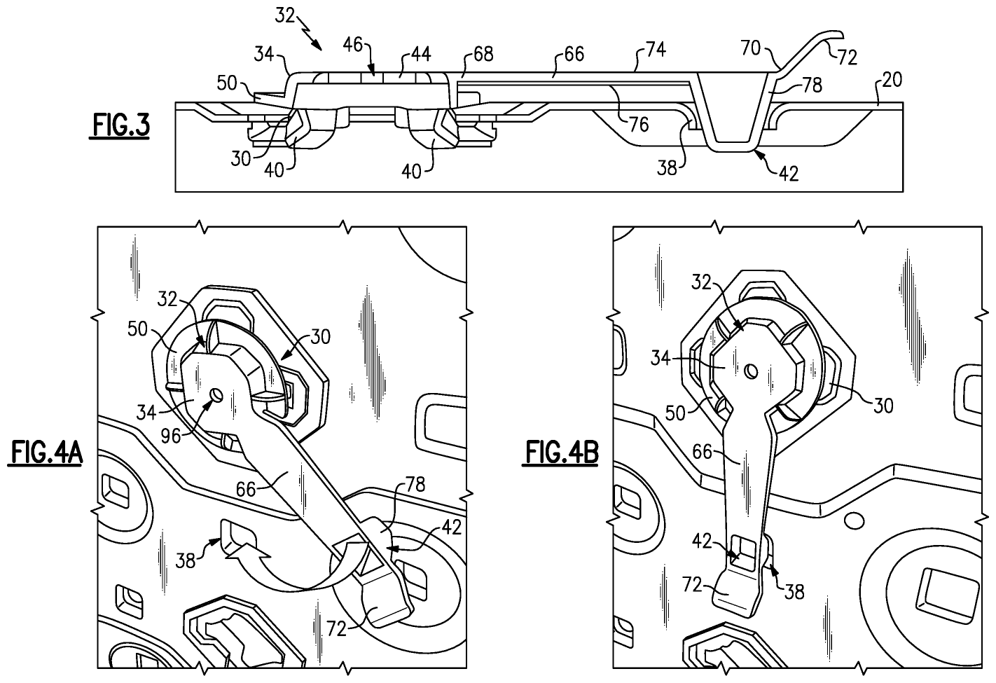

In one example, each mounting foot 40 comprises a base end 60 attached to the base support 34 via the flange portion 58. Optionally, the mounting feet 40 could extend directly from the base support 34. In one example, each foot 40 extends to a distal end 62 that is bent at an angle relative to the base end 60 as shown in FIG. 2C. The distal ends 62 are positioned radially outwardly relative to the base ends 60. In one example, a transition between the base end 60 and the distal end 62 comprises a flexible area to allow the distal ends to flex and/or bend during insertion into the mounting aperture 30. In one example, the plurality of mounting feet 40 are received within only a single mounting aperture 40 in an interference fit (FIG. 3).

In one example, the attachment structure 32 includes an arm 66 that that has a first end 68 associated with the base support 34 and a second end 70 associated with the lock 42 as shown in FIGS. 2A-C. In one example, the arm 66 comprises an elongated body that extends from the first end 68 to the second end 70 to form a straight and flat arm body having a first side 74 and a second side 76 facing opposite of the first side 74. In one example, the second end 70 of the arm 66 further comprises a distal end portion 72 that is bent at an angle relative to the elongated body of the arm 66 to provide a grippable portion.

In one example, the lock 42 comprises at least one tab 78 that extends outwardly of the second side 76 of the arm 66. The tab 78 is received within a lock aperture 38 formed within the base plate 20 between adjacent mounting apertures 30. In one example, the tab 78 comprises a polygonal shaped body that tapers from a wider portion at the arm 66 to a narrower distal end portion that is fit into the lock aperture 38. The tapered body facilitates insertion into the lock aperture 38 and creates a wedging effect.

The distal end portion 72 of the arm 66 can be gripped to move the tab 78 into and out of the lock aperture 38. In one example, the arm 66 is narrowed at the first end 68 by the base support 34 to provide a flexible connection interface to allow the arm 66 to flex as the tab 78 is inserted into the lock aperture 38 to lock the attachment structure 32 in place, and to flex as the tab 78 is pulled out of the lock aperture 38 to unlock the attachment structure 32. In one example, a central area of the elongated body of the arm 66 can be slightly thinned to increase the flexibility of the arm 66.

An exemplary method of attaching the attachment structure 32 to the base plate 20 includes inserting the plurality of mounting feet 40 into a single mounting aperture 30 of the plurality of mounting apertures 30. In one example, during insertion, the mounting feet 40 are aligned with the corners of the diamond-shaped mounting hole 30 as shown in FIG. 4A. After inserting the plurality of mounting feet 40 into the single mounting aperture 30, the method further includes rotating the base support 34 and mounting feet 40 until the lock 42 aligns with one lock aperture 38 of the plurality of lock apertures 38. As shown in FIG. 4B, this locks the feet 40 in place along the sides of the mounting aperture 30, and the tab 78 can then be inserted into one of the lock apertures 38. When in the locked position, the feet 40 extend underneath the base plate 20 such that the base portion 34 cannot be removed. To unlock and remove the attachment structure 32, the reverse operation is performed.

FIG. 7 shows an example of using multiple attachment structures 32 to attach an accessory 22 to the base plate 20. In this example, the mounting feet 40 of a first attachment structure 32a are inserted into one mounting aperture 30a and the mounting feet 40 of a second attachment structure 32b are inserted into another, adjacent, mounting aperture 30b. The lock 42 of the first attachment structure 32a is inserted into one lock aperture 38 and the lock 42 of the second attachment structure 32b is inserted into another lock aperture 38. A support member 48, such as a bin, box, tote, basket, etc. is attached to the attachment structures 32a, 32b using fasteners 80 that are attached via the attachment interface 46 on the base support 34. Once the support member 48 is attached, items and accessories can be stored within the support member 48. The tabs 78 are positioned such that they are not covered by the support member 48. Further, while two attachment structures 32a, 32b are shown, it should be understood that additional attachment structures 32 could be used as needed for the support member 48.

In one example, the attachment structure 32 can be configured to receive power from a vehicle power source. This power can then be supplied to an accessory 22 as needed.

In one example, the attachment structure 32 comprises a molded, high strength, polyamideimide reinforced plastic reinforced with fiberglass or graphite. Other similar materials could also be used. In one example, the mounting feet 40 could be formed using a dual shot process to make it easier to turn the attachment insert.

The subject disclosure provides an attachment structure for an accessory that can quickly and easily attach to a base plate. Further, the attachment structure has high strength and is easily adaptable to support multiple different type of accessories. No tools or fasteners are needed for fast and easy attachment of the accessory support to the pattern of mounting apertures on the base plate.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An attachment structure, comprising:
a base support with a plurality of mounting feet and a lock separate from the base support, wherein the base support is configurable to hold one or more items on a base plate, and wherein the plurality of mounting feet are configured to be received within one mounting aperture of the base plate.

2. The attachment structure of claim 1, wherein the base support includes a base surface with at least one attachment interface that cooperates with a support member to hold the one or more items.

3. The attachment structure of claim 2, wherein the base support includes a flange surrounding a majority of the base surface and a wall that transitions from an inner peripheral portion of the flange to the base surface such that the base surface comprises a raised boss.

4. The attachment structure of claim 2, wherein the base support includes a first side with the base surface and a second side facing opposite the first side, and wherein the plurality of mounting feet extend outwardly of the second side of the base support and are spaced circumferentially apart from each other.

5. The attachment structure of claim 4, wherein each mounting foot comprises a base end attached to the base support and which extends to a distal end that is bent at an angle relative to the base end.

6. The attachment structure of claim 5, wherein the plurality of mounting feet are received within one single mounting aperture in an interference fit.

7. The attachment structure of claim 1, wherein the attachment structure includes an arm that that has a first end associated with the base support and a second end associated with the lock.

8. The attachment structure of claim 7, wherein the lock comprises at least one tab that extends outwardly of a base plate facing surface of the arm, and wherein the at least one tab is received within a lock aperture formed within the base plate, the lock aperture being different from the one mounting aperture.

9. The attachment structure of claim 8, wherein the arm comprises an elongated body that extends from the first end to the second end, and wherein the second end of the arm comprises a distal end portion that is bent at an angle relative to the elongated body to provide a grippable portion.

10. An attachment system, comprising:
a base plate having a plurality of mounting apertures; and
an attachment structure comprising a base support with a plurality of mounting feet and a lock separate from the base support, wherein the base support is configurable to hold one or more items, and wherein the plurality of mounting feet are received within one mounting aperture of the plurality of mounting apertures to attach the attachment structure to the base plate.

11. The attachment system of claim 10, wherein the base plate is mounted within a cargo area of a vehicle.

12. The attachment system of claim 10, wherein the base support includes a base surface with at least one attachment interface that cooperates with a support member to hold the one or more items.

13. The attachment system of claim 12, wherein the base support includes a first side with the base surface and a second side facing opposite the first side, and wherein the plurality of mounting feet extend outwardly of the second side of the base support and are spaced circumferentially apart from each other.

14. The attachment system of claim 13, wherein the each mounting foot comprises a base end attached to the base support and which extends to a distal end that is bent at an angle relative to the base end, and wherein the plurality of mounting feet are received within a single mounting aperture of the plurality of mounting apertures in an interference fit.

15. The attachment system of claim 10, wherein the attachment structure includes an arm that comprises an elongated body extending from a first end at the base support to a second end that includes the lock.

16. The attachment system of claim 15, wherein the lock comprises at least one tab that extends outwardly of a base plate facing surface of the arm, and wherein the base support is rotatable to move the plurality of mounting feet between an unlock position and lock position, and wherein arm is rotatable to move the plurality of feet to the lock position while also aligning the at least one tab with a lock aperture formed within the base plate.

17. The attachment system of claim 16, wherein the second end of the arm comprises a distal end portion that is bent at an angle relative to the elongated body to provide a grippable portion.

18. A method comprising:
providing a base plate with a plurality of mounting apertures and a plurality of lock apertures that are separate from the plurality of mounting apertures;
forming an attachment structure to comprise a base support with a plurality of mounting feet and a lock separate from the base support;
inserting the plurality of mounting feet into a single mounting aperture of the plurality of mounting apertures; and
inserting the lock into one lock aperture of the plurality of lock apertures.

19. The method of claim 18, wherein after inserting the plurality of mounting feet into the single mounting aperture, the method further includes rotating the base support until the plurality of mounting feet are in a lock position and the lock aligns with one of the plurality of lock apertures.

20. The method of claim 18, including attaching one or more items to the base support.
